(19) United States
(12) Patent Application Publication
(10) Pub. No.: US 2017/0068523 A1
(43) Pub. Date: Mar. 9, 2017

(54) Modular Computer Application Development and Usage

(71) Applicant: Zhenyu Zhu, Fremont, CA (US)

(72) Inventor: Zhenyu Zhu, Fremont, CA (US)

(73) Assignee: Zhenyu Zhu

(21) Appl. No.: 14/846,527

(22) Filed: Sep. 4, 2015

(51) Int. Cl. G06F 9/445; H04L 29/08

(52) U.S. Cl. CPC G06F 8/60; H04L 67/1097

(57) ABSTRACT

This is a process, with supporting apparatus, to facilitate modular software application and knowledgebase development and usage in a searchable, cumulative and automated manner.

Developer and users deploy and access the application/knowledgebase with integrated process through the application call manager. A standardized data container is used to store various types of data in the entire process. Depends of user action, the process can automatically record or use parametric information of the target applications to manual or batch call applications or load knowledgebase of the applications.

The standardized data container also serves a data and application call knowledgebase template and facilitates knowledge transfer between users and developers.

### BACKGROUND OF THE INVENTION

A software package can be viewed as a plurality of computer applications, each designed to perform a different function or process. A computer application can be executed interactively or in batch mode. An interactive run of an application means the application “interacts” with a user, such that it requires input from the user and can provide an output to the user. A batch run of applications can be defined as to run applications without intermediate input from the user.

For a computer application to be initiated and perform proper logic execution, human-computer interaction is needed throughout this process. The human-computer interaction includes two main approaches: direct command input (An example is the UNIX system) and graphical user interface (An example is the WINDOWS system). Regardless of the interaction method, in order for an application to run properly, generally three types of data are needed; invariable data (such as application name and location), variable data (application parameters) and optionally the target data that application logic will perform upon and/or generate. Both of the human-computer interaction approaches have limitations in conveying the three types of data to the computer. The direct command input is limited by user's ability to remember and efficiently correlate the commands, parameters and the target data. Therefore, it is not as popular as the more intuitive graphical user interface (GUI) approach. However, the GUI is also limited, by generalizing all functionality and possible input scenarios into limited statically design structure of GUI. This generally results in lengthy application development cycle and learning curve for the user. In addition, the GUI implicitly prohibits the batch execution of the applications.

Before the software is developed, the developers needs to define the scope of features potentially needed by the users. However, at this stage, the developers generally lack the ability to gather feedback easily from users and customers. In the meantime, the feature requirement from the user before and after the software is deployed, may be fragmented, inconsistent and lack of mechanism to feedback correctly and timely to the developer. Without such feedback, it is difficult for the developers narrow down and prioritize the features to be developed. Often the development resources are limited such that optimally allocate and leverage development resources is crucial for the success of software development. The problem becomes further acute, when the software developing, testing and deploying activities become distributed around the world.

Even after the features are well defined with abundant developing resource, the developers still need to generalize the target features into limited input methods (commands or GUIs), due to the limited resources (such as time, knowledge and attention span) from the user to utilize the software product. It is also difficult to combine large number of functions into one generalized software package. The level of difficulty in development grows at a faster pace than the complexity of the software. As a result, the developing process demands highly skilled and specialized developer and the developing process is generally lengthy and costly.

When the features offered by the software increases, which is the general trend of the software developing practice, the learning curve from the user also grows very fast. This is because the user needs to navigate through all the features with the corresponding input scenarios before the user can correctly correlate the feature, parameter and target data with specific needs of each incidence.

Experience user in general has the skills to quickly identify a set of functions provided by the software to meet the demands of processing a particular set of information, and correlate the functions to the commands or the actions within the GUI context.

When a user got more familiar with a software package, due to the repetitive nature of the GUI, the need for batch execution of software usually becomes more pressing. In general, batch execution of application needs two kinds of information: application sequence and application parameter. Due to the statically designed generalized nature of the GUI, it is difficult to summarize user-software interaction into reusable information for future automatic batch execution of the application.

Therefore, there is a need for a process with the following features:
An alternative approach to facilitate software-user interaction, other than direct command input and graphical user interface, are needed.
Bridge the gap between developer and user, both in the needs for software features and software usage knowledge.
Lower the software development risk, effort and lower the requirement of the software developer.
Given the distributed locations of the developers and users, facilitate more transparent software deployment and usage with less effort from the developers and users.
Shorten the learning curve of software, and improve software usage efficiency.
Provide a method to establish correlation between software logic and data for the user, in an intuitive, cumulative and automated manner.

### SUMMARY OF INVENTION

This invention addresses the above-described needs through a process that includes but not limited to a combination of the following key features: decoupled individual application modules, hybrid local-cloud distributed application library as well as application index, data container with standard modular data structure, and an integrated process using the application call manager.

With this invention, the developer can divide the general application package into multiple decoupled application modules. Each application module is intended to achieve specific task with simple logic and clearly defined data interface. In turn, the individual applications can be developed, deployed and maintained in distributed manner on demand basis.

The hybrid local-cloud based application storage facilitates easier deployment for the developer, while also allowing user to strike a balance of faster application call and more transparent application usage.

A hybrid local-cloud application index can be used to facilitate user directly call relevant applications through GUI assisted command input. The index is dynamically customizable by the developer and the user, with standard data structure offered by the data container described below.

The user-application data interface uses the modular data container with standardized data structure (XML format can be one example of the format to be used). The data container, which can host both logic entries and data objects, is directly accessible by the user. The logic entries might include the name of application and the parameters needed to complete the intended logic of the application. The data objects might include input data, output data as well as peripheral data (such as help information for the application). The target data and information needed to conduct application call can be deployed in the same package of data container from developer to user or among users of the applications.

Based on the user prepared and selected data within the modular data container, the application call manager decides how to respond to the application call, among other possible actions, such as manual or parametric execution of the applications.

For parametric execution of applications, the application call manager will conduct application call while, depends on the user prepared data, recording new parameters or utilizing existing parameters for each application.

In conclusion, this invention is a process to facilitate modular software application development and usage in an intuitive, cumulative and automatable manner.

The various aspects of the present invention may be more clearly understood and appreciated from a review of the following detailed description of the disclosed embodiments and by reference to the drawings and claims.

### BRIEF DESCRIPTION OF FIGURES

Various exemplary embodiments are illustrated by way of example, and not by way of limitation, in the figures listed below:

FIG. 1 is a schematic illustration of application development, deployment and usage with the application call manager;

FIG. 2 is a schematic illustration of the application call manager components;

FIG. 3 is a schematic illustration of the application call procedure;

FIG. 4: An overview of a sample data container and the entry point of the application call manager

FIG. 5: User initiate call without target application name

FIG. 6: User initiate call with target application name

FIG. 7: User initiate call with target application name and application path

FIG. 8: User initiate call with target application name and application parameter

FIG. 9: User initiate call with information for multiple target applications

FIG. 10: User initiate call with utility application to deploy a new application

### DESCRIPTION OF THE PREFERRED EMBODIMENT

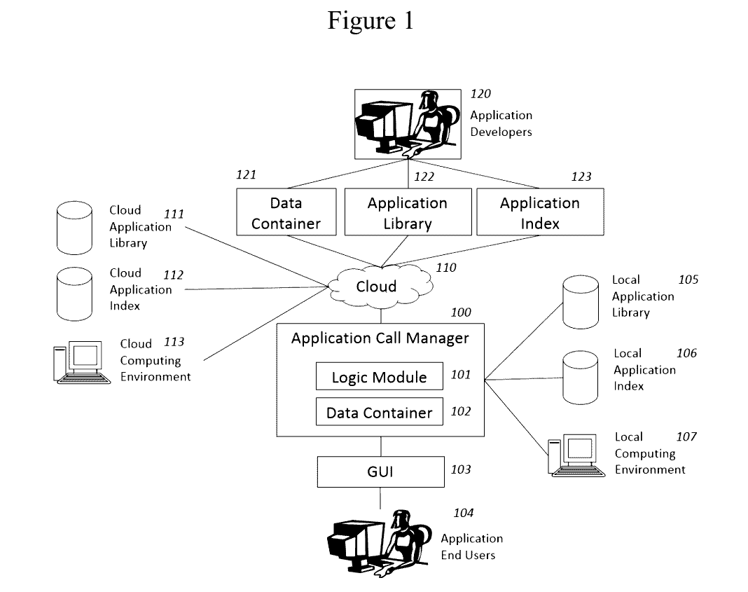

FIG. 1 schematically illustrates an architecture with interaction mechanism among computing resources, users and developers. The figure is used as an embodiment of the present invention.

The process is better illustrated by starting with the application call manager (ACM) 100. The ACM 100 is a package of logic modules 101 and data container 102 that facilitates the interaction between users and applications.

An application end user 104, will use the Graphical User Interface (GUI) 103 to interact with the ACM 100. The GUI 103 can be the built-in interface within ACM 100 and/or the interface provided by other software that communicates with the ACM 100. The ACM 100 also has interface with the Local Computing Environment (LCE) 107. The LCE 107 are the software and hardware resources that are locally available to users. The LCE 107 could be but not limited to a personal computer or computers within the same company domain. In addition to exposing computing resources (file management, networking, licensing, and other application programming interfaces (API) of the operation system or installed software) to ACM 100, the LCE 107 also provides storage service for the Local Application Library (105) and Local Application Index (106), both of which can be accessed by the ACM 100 to respond to the application call from the user 104.

The Local Application Library 105 is a collection of applications with standard interface to respond to the call request from the ACM 100. The key information regarding the applications is stored in the Local Application Index 106. The Local Application Index 106 uses the same data structure offered by the data container 102, and it can be directly accessed by both the ACM 100 and the user 104. The Local Application Library 105 as well as the Local Application Index 106 can be established and maintained either by the developer 120 or by the user 104, using the local or cloud resources. The same setup structure for local application call can be deployed on the cloud 110 with distributed storage and computing resources 113. The Cloud Application Library 111 and the Cloud Application Index 112 can be maintained by the developers for easier deployment or an independent entity to ensure quality and security of the applications hosted.

The Data Container 102 and the Local/Cloud Application Libraries 105, 106, 111 and 112, are created and distributed by the developer 120, shown as items 121, 122 and 123. When the developer 120 distributes the applications to the end user 104, there can be many options to achieve it with a few of them shown below:
1. The developer 120 can upload the application library 122 to the cloud application library 111, update the cloud application index 112 and then notify the end user 104.
2. The developer 120 can upload the application library 122 to the cloud application library 111, send the information about cloud application library 111 to the end user 104 to update the local application index library 106.
3. The developer 120 can also send the application library 122 directly to the end user 104 to update the local application library 105 as well as the local application index 106. This way, the end user 104 can call the deployed application locally.

In addition, the developer 120 can also deploy the data container 121 with specific knowledgebase about the deployed application. The data container 121 can include the application name, hosting path, application parameters, demo usage of the application and other information to help the end user 104 to better use the application. The data container 121 can be send as independent data file as well as included in the same package as the application. The end user 104 can also use this data container 121 in the form of an independent data file to facilitate communication with the developer 120. This data container 121 can also be distributed between the end users 104 to convey their cumulative knowledge about the application usage. One example of the data contain can be a spreadsheet file, including all the information about a specific application that can be customized and shared as pure data among application users, without distributing the software application itself.

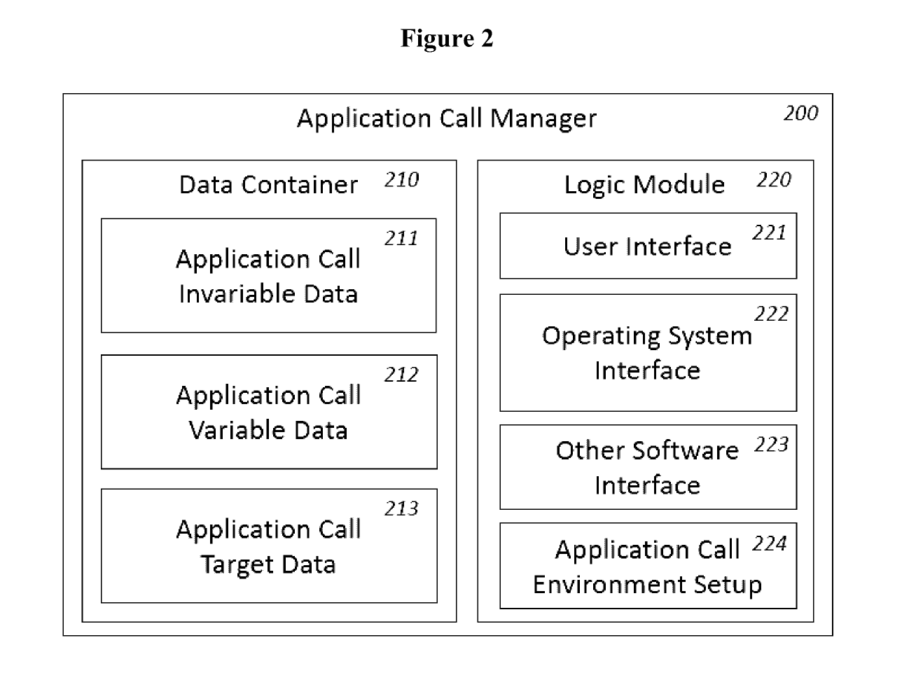

FIG. 2 is a schematic illustration of the application call manager components.

The Application Call Manager (ACM) 200, referred to as 100 in FIG. 1, is described with detailed description about two general components: Data Container 210 and Logic Module 220.

The data container 210 has a modulated data structure. It hosts modular information and/or a link to external information of alien data type. An example of this is a spreadsheet with text numerical information in some of the cells and other cells store hyperlinks to internet addresses or local files. The data container 210 is used to store three categories of data to be used by ACM 200: the application call invariable data 211, the application call variable data 212 and the application call target data 213.

The application call invariable data 211 is the information will remain the same during the application call process. It includes information such as application name and application path, application support information, etc. The application call variable data 212 can also be referred to as parameters, which is additional information needed by the application to uniquely identify the user intended functionality. The application call target data 213 is the data that the application logic will operate upon or generate. The data container can contain any target data either with native data or hyperlinks as a pointer to the location of the target data. Any data module within the data container can further be viewed as an object module. Hence, the pointer to a predefined programming object can be used to directly expose the object property and method in the data container to the user. The programming object has the same definition as the Object Oriented Programming (OOP). In addition to collect and modify information of the object property, user can easily access the object exposed method and events using the data container without any programming from the user.

The logic module 220 includes four functional components: the user interface 221, interface with operating system 222, interface with other software 223, and the application call environment setup utility functions 224 that facilitate the application call.

The user interface 221 responds to the user input of calling the application and user interaction during the application execution. The application call is generalized into one step action for the user. However, the user selection within the data container 210, the actual data within the user selected data as well as user manual input from the GUI will determine the corresponding application call scenarios. In a special case, the software application can be a dummy application, which does not include any software logic. Then the user can use this dummy application to only load knowledgebase stored in the data container 210.

The interface with operating system 222, as well as the interface provided by other software 223, allow the ACM 200, with the functions in application call environment setup 224, to access necessary resources and expose to each individual application. The functions in application call environment setup 224 may include but not limited to the setting of the firewall, user privilege, network and printing.

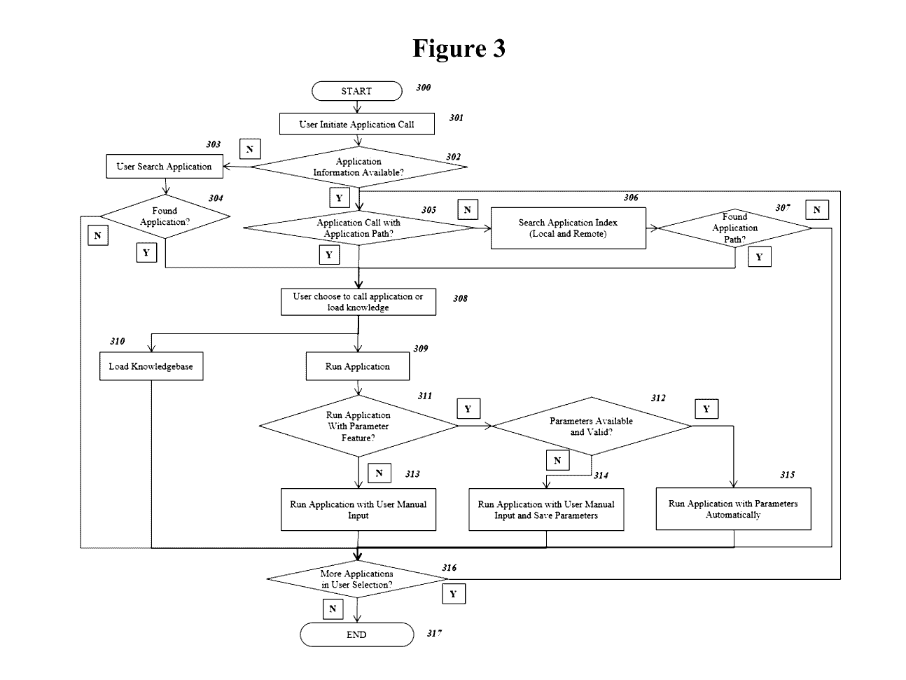

FIG. 3 illustrates the process for the ACM 200 to conduct the application call.

The process starts with step 300.

From step 301, user select a set of information within the data container 210 and initiate the application call through the ACM 200. Since data container 210 is a component of ACM 200, this implies that the ACM 200 needs to be loaded in the memory before the application call. The user selected information includes two types of data for the applications call: invariable data 211 and variable data 212. A combination of the availability and validity of user selected information will determine how the ACM 200 will react to the user application call. In step 302, the ACM 200 check if the application name is available within user selected information. In the case of no information is available (No in step 302), the ACM 200 responds with a search interface in step 303. In the search interface, user tries to find the target application through keyword based search. After the user finds the target application in step 304, the ACM 200 will save the application invariable data 211 within the data container 210 and proceed to step 308 with only the invariable data 211.

In the case of application name is available (Yes in step 302), the ACM 200 further checks if the application path is available and valid in step 305. If the application path is provided and validated (Yes in step 305), the ACM 200 proceeds to step 308. Otherwise (No in step 305), the ACM 200 will proceed to step 306 and conduct search in the application index (first in local index and then in remote index). The local index is searched first, hence has higher priority than the remote index. If the application path is found and validated, ACM 200 will proceed to step 308.

In step 308, user choose to call the application or load the knowledgebase about the application through the ACM 200. The user chooses the two options using behavior override. The user application call as well as behavior override are generalized into a single step of human-computer interaction, to achieve user friendliness and easy access. The input can be facilitated with a combination of a plurality of methods including but not limited to keyboard input, mouse movement/click, recognizable user gesture/voice or touch screen input. For example, user can use mouse click a menu button to call application, while pressing down SHIFT key to override the call application to load knowledgebase.

If user chooses to run application (step 309), the ACM 200 first loads the target application into memory. The target application is generally loaded into the local computing environment 107. However, if needed, the cloud computer environment 113 can be used to load and run the target application. In this step, the ACM 200 will expose needed computer resource and setup proper environment for the application to be loaded successfully. Then the ACM 200 will proceed to step 311.

If user chooses to load application knowledgebase (step 310), the ACM 200 loads the target application knowledgebase into memory and make the knowledgebase available to user and then proceeds to step 316.

In step 311, the ACM 200 check if user is trying to run the application with parameter feature. The parameter feature essentially directs the ACM 200, during an application call, to either use existing parameters or record parameters during user manual input. If use wants to run the application with parameter feature (Yes in step 311), the ACM 200 proceeds to step 312.

If the user does not intend to include the parameter feature in the application run (NO in step 311), the ACM 200 proceeds to step 313. In step 313, the application is executed with manual input of any necessary parameters from the user. However, the user input parameters are not saved during the process. In this case, the application call behaves the same as most of the GUI based software applications in the current practice. Upon successful execution of step 313, the ACM 200 will proceed to step 316.

In step 312, the ACM 200 checks if the application parameter (application variable data 212) is available and valid. If the application parameter is not available or cannot be validated (No in step 312), the ACM 200 will proceed to step 314. If the application parameter is available and validated (Yes in step 312), the ACM 200 will proceed to step 315.

In Step 314, the ACM 200 run the application and interact with user if needed. The user input, which is considered application variable data 212 is saved to the target location within the user selected data of the data container 102. Upon successful execution of step 314, the ACM 200 proceeds to step 316.

In step 315, the application is executed without any further input from the user. The application call behaves the same as automated batch execution of the application. Upon successful execution of step 314, the ACM 200 proceeds to step 316.

In step 316, ACM 200 checks if the user has selected a range with more than one application. If any further application call needs to be processed, the ACM 200 loops back to step 305. The loop will continue similar to a script batch run. After all selected application calls are processed, the ACM 200 ends the application call with step 317.

While the invention has been particularly shown and described with reference to a preferred embodiment, it will be understood by those skilled in the art that various changes in form and detail may be made therein without departing from the spirit and scope of the invention.

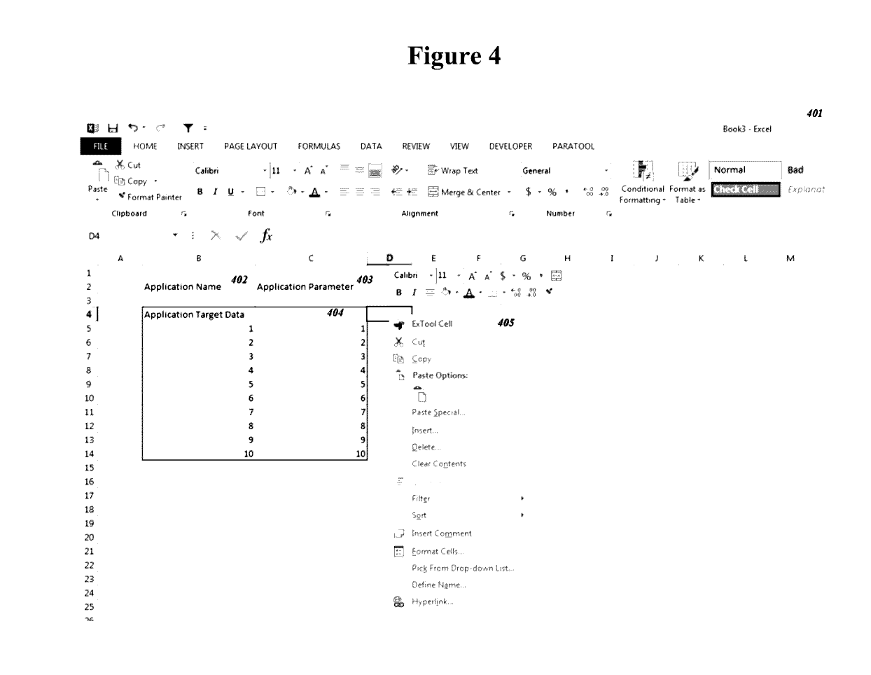

FIG. 4 uses a series of examples to illustrate sample implementation of the process described in FIG. 3.

In the examples, the process is implemented as an extension to the Microsoft Excel software. The application call manager (ACM 200) is an add-in of the hosting software Excel. The Excel interface is used to facilitate user application call. The excel worksheet is used as the data container. The same process can be applied to other software with similar modular data storage structure as the spreadsheet.

The following figures are described in sequence:

FIG. 4: An overview of a sample data container 210 and the entry point of the ACM 200

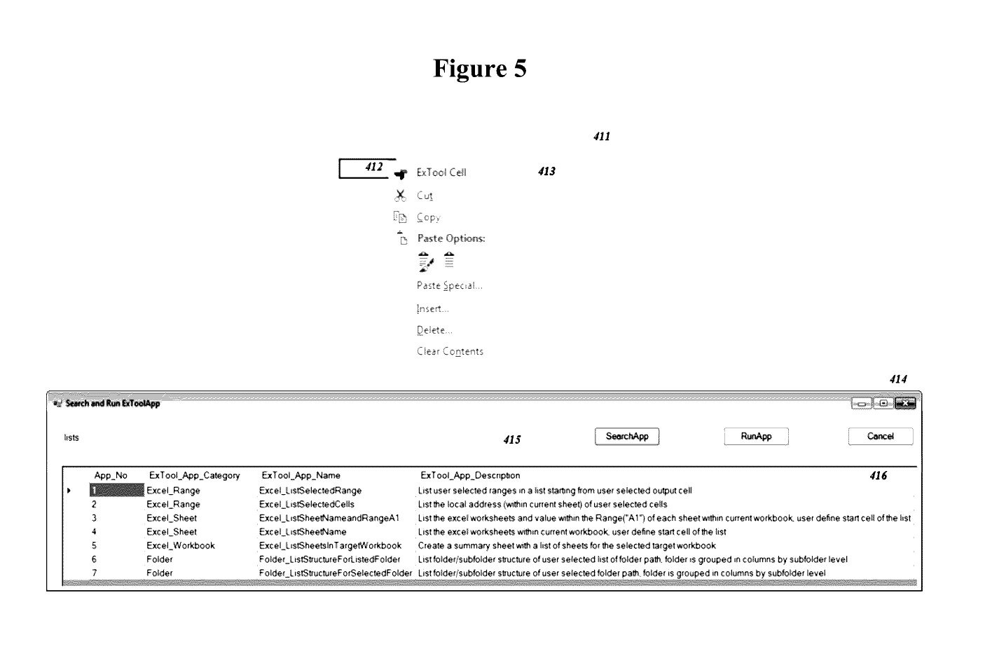

FIG. 5: User initiate call without target application name

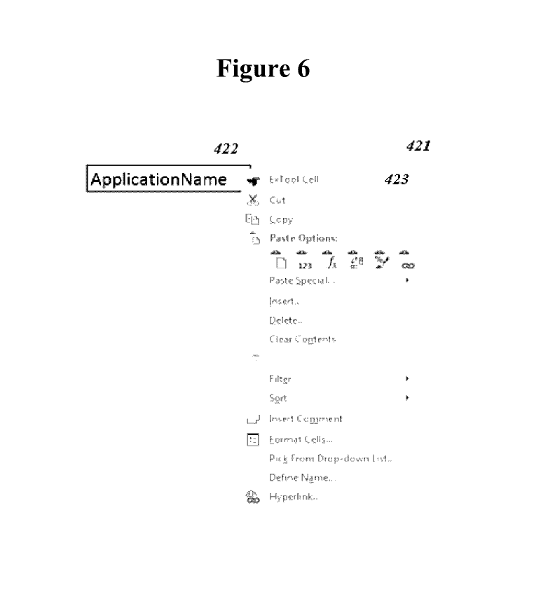

FIG. 6: User initiate call with target application name

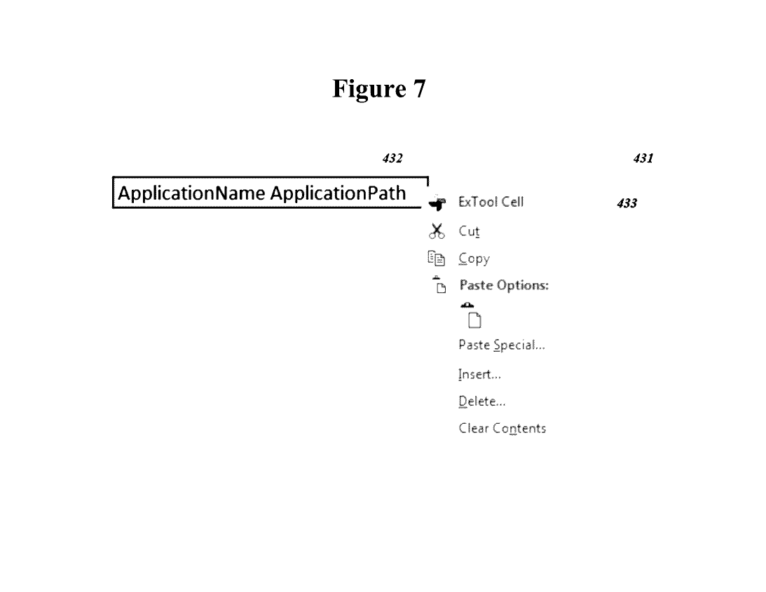

FIG. 7 User initiate call with target application name and application path

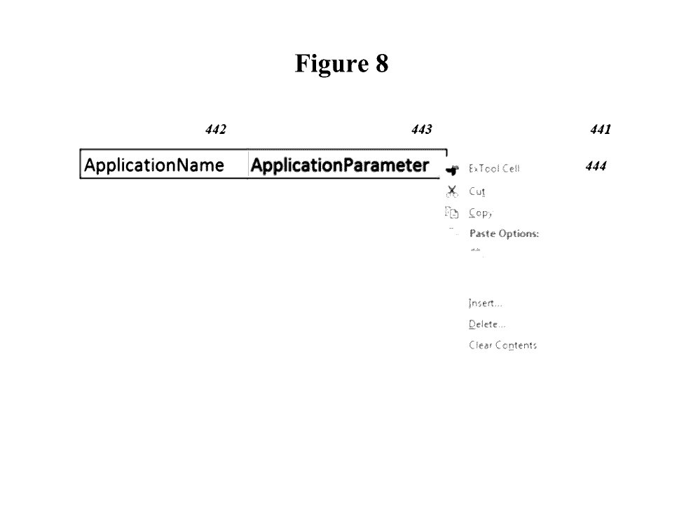

FIG. 8: User initiate call with target application name and application parameter

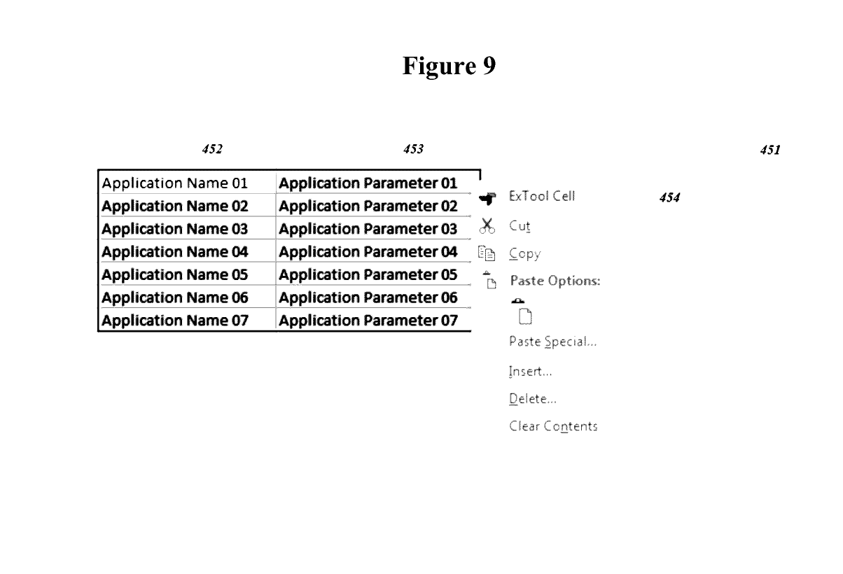

FIG. 9: User initiate call with information for multiple target applications

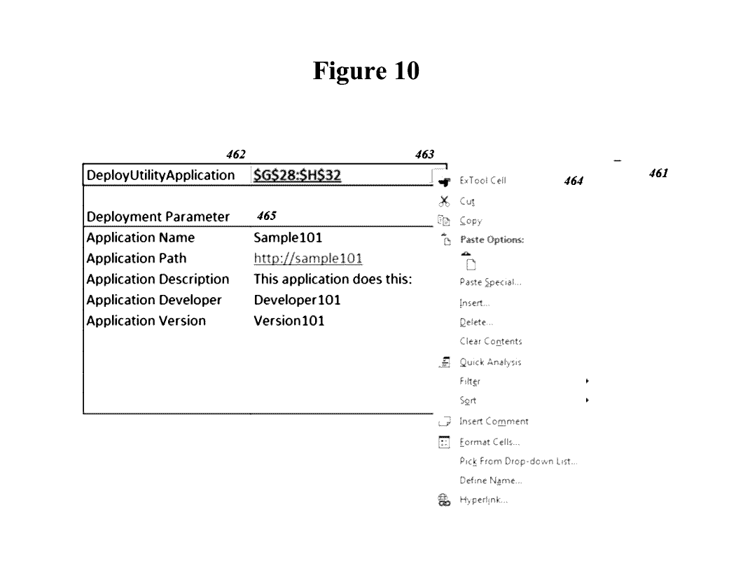

FIG. 10: User initiate call with utility application to deploy a new application

FIG. 4 shows an overview of application call menu and various data all within the data container 210. The excel interface 401 is shown as the background. In this sample implementation, the data container 210 is essentially an excel worksheet. The data within cell 402 may include application name and application path. The cell 402 corresponds to the Application Call Invariable Data 211 in FIG. 2. The cell 403 may include application parameter. The cell 403 corresponds to the Application Call Variable Data 212 in FIG. 2. The application target data 404 may be one or multiple range of cells. The target data 404 could also be other objects within excel, including but not limited to charts, shapes and images. The cell 404 corresponds to the Application Call Target Data 213 in FIG. 2. The data container can only store information, either internal information allowed within excel sheet or reference links to external information. The reference links might include but not limited to hyperlinks to a file and a webpage URL over the internet. The data container does not have any program coding, such that it can be shared between developers and users as pure data. The application that operates on the target data within the data container 210 is called from the library and ran independently from the data container 210 and its hosting program. The application call is initiated through the ACM 200 entrance point, which is implemented as one option (“ExTool Cell”) 405 of cell context menu upon the mouse right click over the excel cell.

FIG. 5 shows the excel sheet 411 as background. When user right click on an empty cell 412, the right click menu with an option of the “ExTool Cell” 413 is shown. When the user select the option 413, as the target cell is empty in this example, the ExTool search dialog 414 is shown. In the search dialog, user can input the keyword within the search text box 415 to search for target application. The ACM 200 shows a search summary table 416 with key envelope information for the applications returned from the search process. The key envelope information includes but not limited to: application category, application name, application function description. The use then select and call the target application from the table. The ACM 200 then executes the application and saves the application name into the selected cell 412.

If user implies a behavior override, by pressing down SHIFT key as implemented in this example, while selecting and calling the application, the ACM 200 load the knowledgebase for the target application instead of calling the application. The knowledge base is essentially data that saved in the standardized data container 210.

The data container 210, as implemented in this example, is in the form of one or multiple Excel sheets. The same behavior override is applicable to all of the following examples.

FIG. 6 shows the excel sheet 421 as background. When user right click on a cell 422, the right click menu with an option of “ExTool Cell” 423 is shown. In this example, the cell 422 is already filled with the application name. When user select the option 423, the ACM 200 calls the application based on the application name in cell 422.

FIG. 7 shows the excel interface 431 as background. When user right click on a cell 432, the right click menu with an option of “ExTool Cell” 433 is shown. In this example, the cell 432 is already filled with the application name and application path. When user select the option 433, the ACM 200 calls the application based on the application name in cell 432.

FIG. 8 shows the excel sheet 441 as background. User first select two side by side cells 442 and 443. The cell 442 is already filled with the application name. In this example, the cell 443 is already filled with the application parameters. When user right click on the selected cells 442 and 443, the right click menu with an option of “ExTool Cell” 444 is shown. When user select the option 444, the ACM 200 calls the application based on the application name and parameters in cell 442 and 443.

FIG. 9 shows the excel sheet 451 as background. User first select a range of cells with two columns, 452 and 453. In this example, the column 452 is already filled with the application name and the column 453 is already filled with the application parameters. When user right click on the selected cells 432 and 433, the right click menu with an option of “ExTool Cell” 434 is shown. When user select the option 434, the ACM 200 calls the applications by looping through all rows selected in column 432 and 433 with the application name and parameters.

If the any cell within column 453 is empty, the ACM 200 interacts with user to get user input as parameter and save the parameter in the cell within column 453 upon successful execution of the target application.

If user only select cells within one column 452, then the ACM 200 loops through all target applications without using any existing parameters or saving any user input parameters.

FIG. 10 shows the excel sheet 461 as background. User first select two side by side cells 462 and 463. The column 462 is already filled with the application name. In this special case, the application is a utility application that can deploy a new application into the application library and register the target application in the application index. The cell 463 is already filled with the application parameters, which points to the application deployment parameter table 465. The application deployment parameter table 465 includes all essential information of the application, including but not limited to Application Name, Application Path and Application Description. When user right click on the selected cells 462 and 463, the right click menu with an option of “ExTool Cell” 464 is shown. When user select the option 464, the ACM 200 calls the utility application and deploys the application. The deployment actions include but not limited to, upload/copy file to target path at local and/or cloud storages, write the application entry to the target database and register the application for target user group.

The example demonstrated in FIG. 10, essentially follows the example shown in FIG. 8 for a specific application. However, it could also follow the approach shown in any other potential approach allowed in FIG. 3.

In addition, the example shown in FIG. 10 is flexible to allow various application deployment scenarios. A few examples scenarios are described hereby:
1. A developer developed an application for personal usage. Hence, the user save the application within local application index only and point to the application saved within the local computer.
2. A developer developed an application to be shared with limited peer users. Hence the developer uploads the application to personal storage over the internet and shared to target users. Then the developer send the index entry for his application to target uses to update their index.
3. A user created a knowledgebase unit (For example, an Excel chart template to be used company wide.). The user upload the knowledgebase index and template to a central storage located within the company intranet, to be used by the employees of the entire company.

What is claimed is:

1. A process, with supporting apparatus, of modular software application deployment and usage through application call manager, standardized data structure, and local/cloud hybrid storage and index.

2. The method according to claim 1, further comprising: the application call manager implements integrated single entry user interface with behavior override option to search application, run application or access the application knowledgebase.

3. The method according to claim 2, further comprising: the application call manager facilitates user directly search and execute application.

4. The method according to claim 2, further comprising: the application call manager implements the options for user to call application with direct path or call application with searched path from the application index.

5. The method according to claim 2, further comprising: the application call manager implements the options for user to include or exclude automated recording and retrieving of the application variable data.

6. The method according to claim 2, further comprising: the application call manager implements the options for user to use cloud or local resource to conduct the application call.

7. The method according to claim 2, further comprising: the application call manager implements automatically recording the manual input from user regarding the application invariable data and application variable data.

8. The method according to claim 2, further comprising: the application call manager implements automatically retrieving the existing application invariable data and application variable data and run application without user manual input.

9. The method according to claim 2, further comprising: the application call manager implements flexible number of application calls in sequence with the same application call procedure.

10. The method according to claim 2, further comprising: the application call manager integrates the application deployment and run process. The application deployment is essentially running a deployment utility application.

11. The method according to claim 1, further comprising: using a data container with modular data structure, directly accessible to users, to combine, store and transfer application data.

12. The method according to claim 11, within the same data container, store any data related to the application call, including the application target data, application invariable data and application variable data.

13. The method according to claim 11, further comprising: using the data container to store unique identification of programmable objects and allow non-programming parametrical access to the target objects, using the application as a middleware.

14. The method according to claim 11, further comprising: a method of using the deployable knowledgebase data container to establish, cumulate and convey knowledge among the developers and the users of the application.

15. The method according to claim 1, further comprising: a process of cloud (internet) based distributed development, deployment and usage of the application modules, facilitated by the local/cloud hybrid application index that has standardized data structure, offered by data container, with user customizable content.

16. The method according to claim 15, search application from the local/cloud hybrid index with priority level.
